(19) United States
(12) Patent Application Publication
(10) Pub. No.: US 2020/0394084 A1
(43) Pub. Date: Dec. 17, 2020

(54) SYSTEMS AND METHODS FOR CONTROLLING DELIVERY OF NOTIFICATIONS ON A PER USER BASIS

(71) Applicant: Citrix Systems, Inc., Fort Lauderdale, FL (US)

(72) Inventors: Vipin Borkar, Bengaluru (IN); Santosh Sampath, Bengaluru (IN)

(21) Appl. No.: 16/440,523

(22) Filed: Jun. 13, 2019

(51) Int. Cl. G06F 9/54; G06F 9/455

(52) U.S. Cl. CPC G06F 9/542; G06F 2009/45595; G06F 9/45558

(57) ABSTRACT

Systems and method for controlling delivery of notifications on a per user basis. An agent, executed by a virtual machine, can establish one or more hooks to intercept notifications from an operating system of the virtual machine and one or more virtualized applications executed by the virtual machine accessible by a plurality of users. The agent can intercept, via the one or more hooks, a plurality of notifications for a plurality of users generated by the one or more virtualized applications or the operating system. The plurality of notifications can be sorted on a per user basis. The agent can communicate each user's notifications to a notification service to sort and aggregate the notifications with notifications from a plurality of applications used by each of the plurality of users. The notification service can select one or more notifications to provide to at least one device of a user.

### BACKGROUND

Operating systems can provide controls to various applications executing on a computing device regarding the ability to adapt or integrate the different functionalities of the applications. For example, the operating system can include policies that restrict or deny certain functionalities or limit the ability of one or more applications to interact with other applications executing on the computing device. Thus, complete integration between the various applications and systems on the computing device can be restricted or limited unless a user is actively interacting with the respective application.

### SUMMARY

Systems and methods for controlling delivery of notifications on a per user basis are provided herein. In embodiments, an agent can be provided to a virtual session or a virtual machine providing a session for a user. The virtual machine can run one or more virtual applications accessible by one or more users. The agent can hook the virtual applications and an operating system of the virtual machine to intercept notifications generated by the virtual applications and/or the operating system of the virtual machine. The notifications can be intended for one or more users of the virtual machine. The agent can sort the notifications on a per user basis and communicate the notifications to a notification service.

The notification service can receive notifications from a variety of different sources. For example, the notification service can receive notifications from agents executing on or more virtual machines, virtualized applications, cloud based applications, web applications, Software as a Service (SaaS) applications or file systems. The notifications from the different sources can be aggregated by the notification service and sorted on per user basis into subsets of notifications. Each subset of notifications can correspond to notifications intended for a particular user. The notification service can select one or more notifications from the subset of notifications to push or otherwise provide to at least one device of a user. For example, the device of the user can receive notifications for native applications or the native operating system of the respective device. The device of the user can receive notifications for virtual applications of the user. In embodiments, for virtual application notifications, a user can start a virtual session on the respective device to connect to the virtual application and take an action or respond to an alert generated for the virtual application.

In at least one aspect, this disclosure is directed to a method for controlling delivery of notifications based on a user. The method can include establishing, by an agent executed by a virtual machine, one or more hooks to intercept notifications from an operating system of the virtual machine and one or more virtualized applications executed by the virtual machine accessible by a plurality of users. The method can include intercepting, by the agent via the one or more hooks, a plurality of notifications for a plurality of users generated by the one or more virtualized applications or the operating system. The method can include sorting, by the agent, the plurality of notifications on a per user basis. The method can include communicating, by the agent, each user's notifications to a notification service to sort with notifications from a plurality of applications used by each of the plurality of users.

In embodiments, the notification service can sort each user's notifications from the virtual machine with notifications of the user with notifications from a cloud based application or a file system. The notification service can communicates notifications sorted between the plurality of applications to one or more devices of the user. The method can include identifying, by the notification service, duplicate notifications for the user received from the one or more virtualized applications or the operating system. The method can include removing, by the notification service, the duplicate notifications from the plurality of notifications for each user of the plurality of users.

The method can include generating, by the notification service, a plurality of subsets of notifications, each of the subsets of notifications intended for a different user of the plurality of users. The method can include identifying, by the notification service via the agent, an action requested by the one or more virtualized applications or the operating system of the virtual machine, the action corresponding to at least one notification of the subset of notifications. The method can include identifying, by the notification service, at least one user of the plurality of users associated with the virtual machine and providing, by the notification service, the action to a device associated with the user.

In at least one aspect, this disclosure is directed to a method for controlling delivery of notifications. The method can include receiving, by a notification service from an agent executing in a virtual machine, a plurality of notifications for a user from virtualized applications executed by the virtual machine. The method can include receiving, by the notification service, notifications from other applications of the user. The method can include aggregating, by the notification service, notifications for the user from the plurality of virtualized applications and the plurality of other applications. The method can include selecting, by the notification service, one or more notifications from the aggregated notifications of the user, at least one of the one or more notifications comprising a notification to the user from a virtualized application. The method can include communicating, by the notification service, the selected one or more notifications to a notification system of a device of the user.

In embodiments, responsive to the one or more notifications, a virtual session of the user can be established by the user on the device of the user to connect to the virtualized application. In some embodiments, the notifications from the other applications include at least one of a web application notifications, a Software as a service (SaaS) application notifications, or a file notifications. The method can include generating, by the notification service, an alert for the device of the user to indicate an action requested by the one or more virtualized applications or the operating system of the virtual machine. The method can include providing, by the notification service, a plurality of alerts to one or more devices of the user, the plurality of alerts corresponding to the selected one or more notifications.

In at least one aspect, this disclosure is directed to a system for controlling delivery of notifications based on a user. The system can include an agent executed by a virtual machine. The agent can include one or more processors coupled to a memory. The agent can be configured to establish one or more hooks to intercept notifications from an operating system of the virtual machine and one or more virtualized applications executed by the virtual machine accessible by a plurality of users. The agent can be configured to intercept, via the one or more hooks, a plurality of notifications for a plurality of users generated by the one or more virtualized applications or the operating system. The agent can be configured to sort the plurality of notifications on a per user basis. The agent can be configured to communicate each user's notifications to a notification service to sort with notifications from a plurality of applications used by each of the plurality of users.

In embodiments, the notification service can be configured to sort each user's notifications from the virtual machine with notifications of the user with notifications from a cloud based application or a file system. The notification service can be configured to communicate notifications sorted between the plurality of applications to one or more devices of the user. The notification service can be configured to identify duplicate notifications for the user received from the one or more virtualized applications or the operating system. The notification service can be configured to remove the duplicate notifications from the plurality of notifications for each user of the plurality of users. The notification service can be configured to generate a plurality of subsets of notifications on the per user basis. Each of the subsets of notifications can be intended for a different user of the plurality of users. The notification service can be further configured to identify, via the agent, an action requested by the one or more virtualized applications or the operating system of the virtual machine, the action corresponding to at least one notification of the subset of notifications.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of embodiments of a computing device;

FIG. 1B is a block diagram depicting a computing environment comprising client device in communication with cloud service providers;

FIG. 2 is a block diagram of a system for controlling delivery of notifications on a per user basis; and

FIGS. 3A-3B are a flow diagram of a method for controlling delivery of notifications on a per user basis.

### DETAILED DESCRIPTION

For purposes of reading the description of the various embodiments below, the following descriptions of the sections of the specification and their respective contents may be helpful:

Section A describes a computing environment which may be useful for practicing embodiments described herein; and

Section B describes embodiments of systems and methods for controlling delivery of notifications on a per user basis.

### A. Computing Environment

Prior to discussing the specifics of embodiments of the systems and methods detailed herein in Section B, it may be helpful to discuss the computing environments in which such embodiments may be deployed.

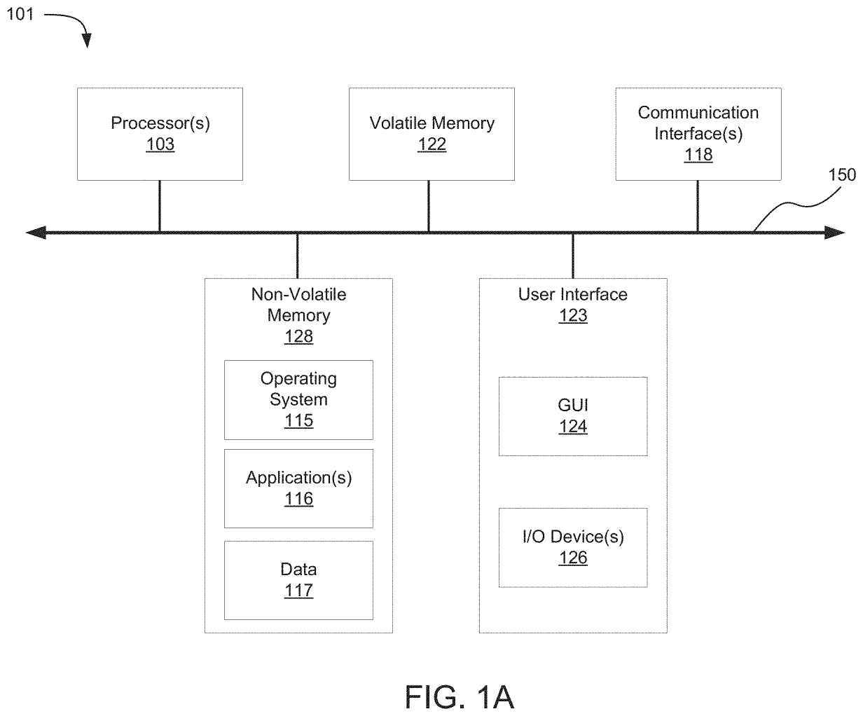

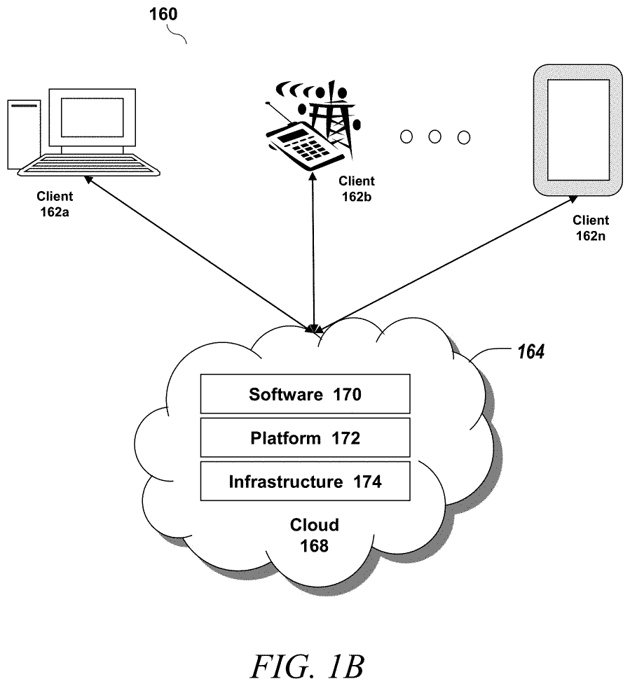

As shown in FIG. 1A, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 162 with one or more resources provided by a network environment. The computing environment 162 may include one or more clients 162a-162n, in communication with a cloud 168 over one or more networks 164. Clients 162 may include, e.g., thick clients, thin clients, and zero clients. The cloud 108 may include back end platforms, e.g., servers 106, storage, server farms or data centers. The clients 162 can be the same as or substantially similar to computer 101 of FIG. 1.

The users or clients 162 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 108 may be public, private, or hybrid. Public clouds 108 may include public servers that are maintained by third parties to the clients 162 or the owners of the clients 162. The servers may be located off-site in remote geographical locations as disclosed above or otherwise. Public clouds 168 may be connected to the servers over a public network 164. Private clouds 168 may include private servers that are physically maintained by clients 162 or owners of clients 162. Private clouds 168 may be connected to the servers over a private network 164. Hybrid clouds 168 may include both the private and public networks 164 and servers.

The cloud 168 may include back end platforms, e.g., servers, storage, server farms or data centers. For example, the cloud 168 can include or correspond to a server or system remote from one or more clients 162 to provide third party control over a pool of shared services and resources. The computing environment 160 can provide resource pooling to serve multiple users via clients 162 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 162. The computing environment 160 can provide an elasticity to dynamically scale out or scale in responsive to different demands from one or more clients 162. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 168 may also include a cloud based delivery, e.g. Software as a Service (SaaS) 170, Platform as a Service (PaaS) 172, and Infrastructure as a Service (IaaS) 174. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 162 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 162 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 162 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 162 may also access SaaS resources through smartphone or tablet applications, including, e.g., Salesforce Sales Cloud, or Google Drive app. Clients 162 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Controlling Delivery of Notifications on a Per User Basis

The systems and methods described herein include controlling delivery of notifications based on an intended user. In an embodiments, an agent can be deployed or provided to a virtual machine and one or more virtual applications can be running on the virtual machine. The agent can hook the virtual applications and an operating system of the virtual machine to intercept notifications generated by the virtual applications and/or an operating system of the virtual machine. In embodiments, the agent can hook notifications from the when a user is connected to a session with the virtual machine or when the session to the virtual machine is disconnected.

The agent can forward or communicate the notifications to a notification service executing on a remote device or server. The notification service can collect notifications from other applications, including the virtual applications executing on the virtual machine and the operating system of the virtual machine. For example, the notification service can collect or intercept notifications from cloud based applications, web applications or file systems. The notifications from the multiple sources can be aggregated by the notification service. In embodiments, the notification service can use one or more policies, analytics, algorithms and/or filters to sort and organize the notifications. For example, the notification service can sort the aggregated notifications on a per user basis or based in part on a user intended to receive the respective notification.

A user can interact with one or more virtual applications through a virtual session. When the virtual session is active and the user is connected to the virtual session, the user is provided actions or work requests from the virtual applications through the virtual session. However, if the user is not actively connected to the virtual session or the virtual application in the virtual session, the action or work requests may not be provided to the user. For example, the user may have to access or open the virtual session or a virtual application to determine if any actions or work need to be performed or if any alerts for the virtual application have been issued. Thus, unless the user is connected to the virtual session, no alert or trigger is provided for the user for any actions or work associated with one or more virtual applications.

In embodiments described here, a user can be provided actions or alerts for one or more virtual applications or an operating system of a virtual machine through a notification service or native operating system of an end point or device of the user. The notification can be provided to the user through the device if the user is not actively connected to the virtual session or the virtual application executing in the virtual session. For example, the agent can be running in the virtual session or virtual machine to hook notifications from virtual applications or an operating system of the virtual machine. In embodiments, the agent can sort the notifications based on a user or intended user and forward the sorted notifications to a notifications service. The notification service can aggregate the notifications received from the agent with notifications received from other sources, including but not limited to, cloud based applications, web applications or file systems. In some embodiments, the notification service can identify and remove duplicate notifications. The notification service can select notifications to form a subset of notifications that are grouped based in part on a user. One or more devices of a user can be identified and the notification service can provide the subset of notifications for a particular user to the one or more devices of the user. In embodiments, the notifications can be provided to the user through a notification system of the respective device or an operating system of the respective device of the user. Thus, the user can receive notifications, actions, and/or work requests from virtual applications without being actively connected to the virtual applications or a virtual machine hosting the virtual applications.

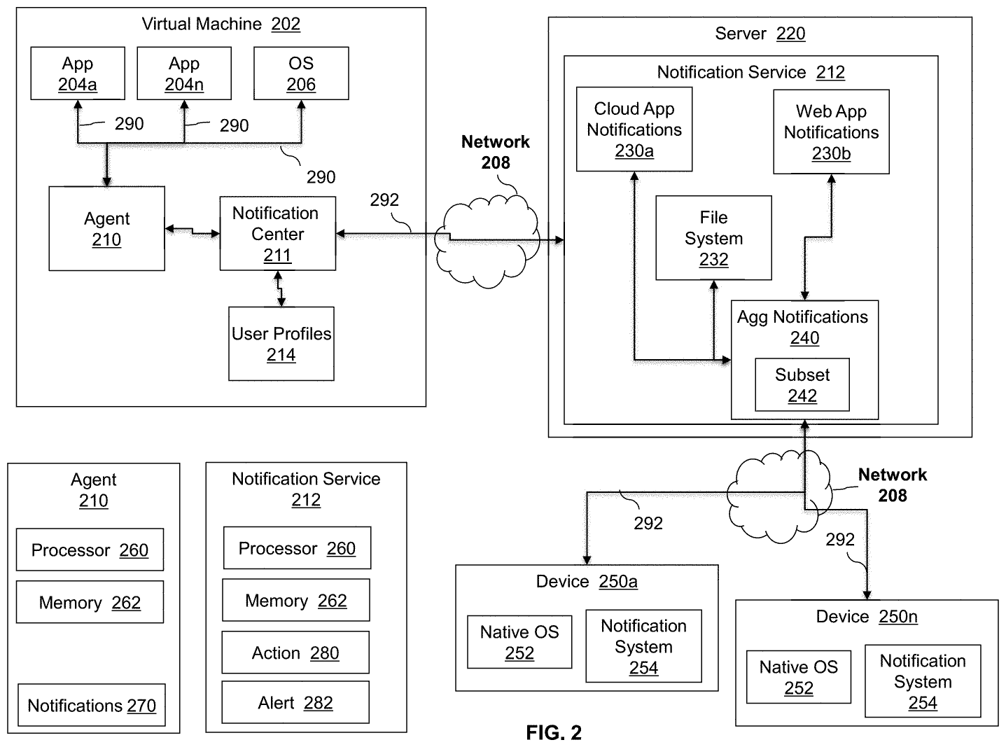

Referring to FIG. 2, depicted is a block diagram of one embodiment of an agent 210 executed by a virtual machine 202 to hook and intercept notifications 270 generated by one or more virtualized applications 204 executed by the virtual machine 202 and/or an operating system 206 of the virtual machine 202. The agent 210 (e.g., notification agent) can forward or communicate the notifications 270 to a notification service 212 executing on a remote device or server 220. The notification service 212 can collect notifications 270 from other applications 230. For example, the notification service 212 can collect or intercept notifications from cloud based applications 230, web applications 230 or file systems 232. The notifications from the multiple sources can be aggregated by the notification service. The notification service 212 can sort the aggregated notifications 270 on a per user basis or based in part on a user intended to receive the respective notification 270.

The virtual machine 202 can include a virtual session or a virtual desktop. In embodiments, the virtual machine 202 can be executing on at least one end point or device 250 of a user. The virtual machine 202 can include a file or an image configured to provide the functionality of a client device or computer (e.g., computer 101 of FIG. 1A). In some embodiments, the virtual machine 202 can provide or execute a session (e.g., user session) for a user. The virtual machine 202 can provide or execute a session within which one or more within which applications execute on behalf of a user or a client computing device, such as a hosted desktop session. The virtual machine 202 can provide or execute a session within which one or more within which one or more virtualized applications 204a-204n execute on behalf of a user or a client computing device, such as a hosted desktop session. In embodiments, the one or more virtualized applications 2044-204n can be executing on or running on the virtual machine 202. The virtual machine 202 can include an operating system 206. The operating system 20 can include software that supports or provides functions for the virtual machine 202. In embodiments, the operating system 206 can include software that runs within or on the virtual machine 202 or software that runs within or on a device or server providing the virtual machine 202.

The agent 210 can include a function, protocol or set of instructions deployed at or executed by at least one virtual machine 202. In embodiments, the agent 210 can include a function, protocol, or set of instructions for hooking and intercepting notifications 270 generated by a virtualized application 204 and/or an operating system 206 of the virtual machine 202. In embodiments, a single agent 210 can be deployed and run on a virtual machine 202. In some embodiments, multiple agents 210 can be deployed and run on a virtual machine 202. The agent 210 can include one or more processors 260 coupled to a memory 262. The processor 260 can include or be coupled to a non-volatile memory that stores computer instructions and an operating system. For example, the computer instructions can be executed by the processor out of volatile memory to perform all or part of the method 300. The agent 210 can include or execute policies and/or rules to hook, intercept and sort a plurality of notifications 270 based in part on an intended user or on a per user basis. For example, the policies can include rules for hooking one or more virtualized applications 204 executed by a virtual machine 202 and/or an operating system 206 of the virtual machine 202. The policies can include rules for intercepting one or more notifications 270. The policies can include rules for determining an intended user a notification 270 was generated for. The policies can include rules for determining a virtualized application 204 or an operating system that generated a notification 270. The policies can include rules for sorting a plurality of notifications 270 into one or more subsets 272 of notifications based in part on a user.

The agent 210 can be implemented using hardware or a combination of software and hardware. For example, each component of the agent 210 can include logical circuity (e.g., a central processing unit or CPU) that responses to and processes instructions fetched from a memory unit (e.g., memory 262). Each component of the agent 210 can include or use a microprocessor or a multi-core processor. A multi-core processor can include two or more processing units on a single computing component. Each component of the agent 210 can be based on any of these processors, or any other processor capable of operating as described herein. Each processor 260 can utilize instruction level parallelism, thread level parallelism, different levels of cache, etc. For example, the agent 210 can include at least one logic device such as a computing device or server having at least one processor to communicate via a network 208. The components and elements of the agent 210 can be separate components or a single component. For example, the agent 210 can include combinations of hardware and software. The agent 210 can include a structured set of data. For example, the agent 210 can include and/or store a plurality of notifications 270 and/or subsets 272 of notifications. The agent 210 can include a memory component 262 (e.g., memory to store and retrieve data. The memory 262 can include a random access memory (RAM) or other dynamic storage device, coupled with the agent 210 for storing information, and instructions to be executed by the agent 210. The memory 262 can include at least one read only memory (ROM) or other static storage device coupled with the agent 210 for storing static information and instructions for the agent 210. The memory 262 can include a storage device, such as a solid state device, magnetic disk or optical disk, coupled with the agent 210 to persistently store information and instructions.

The agent 210 can establish at least one hook 290 to at least one virtualized application 204 executed by the virtual machine 202. The agent 210 can establish at least one hook 290 to an operating system 206 of the virtual machine 202. The hooks 290 can include a connection or session to the virtualized application 204 and/or operating system 206. The hooks 290 can include a function, protocol, or hooking tool provided to the virtualized application 204 and/or operating system 206 by the agent 210 to intercept or receive notifications generated by the virtualized applications 204 and/or the operating system 206 of the virtual machine 202.

The virtual machine 202 can include a plurality of user profiles 214. The user profiles 214 can correspond to a plurality of users having access to the virtual machine 202. The user profiles 214 can include a plurality of entries and each entry can correspond to a unique user. Each entry can include a user identifier, account information for a user, password data for a user, and/or virtualized applications 204 accessed or associated with the user. In some embodiments, the user profiles 214 can include notifications 270 and subsets 272 of notifications. For example, the user profiles 214 can include past or previous notifications 270 and subsets 272 of notifications provided to and/or generated for a user corresponding to the user profile 214. In embodiments, the user profiles 214 can include current notifications 270 and subsets 272 of notifications provided to and/or generated for a user corresponding to the user profile 214.

A notification center 211 can be executed by the virtual machine 202. The notification center 211 can include or correspond to a database or memory to collect, store and sort notifications 270. For example, the notification center 211 can include a plurality of entries. The notification center 211 can be arranged by user, by notification 270, by application 204 or by operating system 206. The notification center 211 can include or correspond to a memory. The memory can be implemented using hardware or a combination of software and hardware. For example, each component of the notification center 211 can include logical circuity (e.g., a central processing unit or CPU) that responses to and processes instructions fetched from a memory unit or database. The notification center 211 can include or correspond to a random access memory (RAM) or other dynamic storage device, coupled with the processor 260 for storing information, and instructions to be executed by the agent 210. The notification center 211 can include or correspond to at least one read only memory (ROM) or other static storage device coupled with the processor 260 for storing notifications 270. The notification center 211 can include or correspond to a storage device, such as a solid state device, magnetic disk or optical disk, coupled with the processor 260 to persistently store information and instructions.

Server 220 can include or correspond to a remote or third party server. Server 220 can include or correspond to a device or remote device. The server 220 can include, provide or host at least one notification service 212. The server 220 can be implemented using hardware or a combination of software and hardware. For example, each component of the server 220 can include logical circuity (e.g., a central processing unit or CPU) that responses to and processes instructions fetched from a memory unit. Each component of the server 220 can include or use a microprocessor or a multi-core processor. A multi-core processor can include two or more processing units on a single computing component. Each component of the server 220 can be based on any of these processors, or any other processor capable of operating as described herein. Each processor can utilize instruction level parallelism, thread level parallelism, different levels of cache, etc. For example, the server 220 can include at least one logic device such as a computing device or server having at least one processor to communicate via a network 208. The server 220 can establish at least one session to at least one device 250 (e.g., end point) to provide one or more selected notifications 270 or subset 272 of notifications to a user of the respective device 250.

The notification service 212 can include an agent, function, protocol or set of instructions executing on the server 220 to collect, aggregate and sort notifications 270 for one or more users. The notification service 212 can include one or more processors 260 coupled to a memory 262. The processor 260 can include or be coupled to a non-volatile memory that stores computer instructions and an operating system. For example, the computer instructions can be executed by the processor 260 out of volatile memory to perform all or part of the method 300. The notification service 212 can include or execute policies and/or rules to sort and filter a plurality of notifications 270 based in part on an intended user or on a per user basis. For example, the policies can include rules for determining an intended user a notification 270 was generated for. The policies can include rules for determining a virtualized application 204, an operating system, other applications 230 and/or a file system 232 that generated a notification 270. The policies can include rules for sorting a plurality of notifications 270 into one or more subsets 272 of notifications based in part on a user.

The notification service 212 can be implemented using hardware or a combination of software and hardware. For example, each component of the notification service 212 can include logical circuity (e.g., a central processing unit or CPU) that responses to and processes instructions fetched from a memory unit (e.g., memory). Each component of the notification service 212 can include or use a microprocessor or a multi-core processor. A multi-core processor can include two or more processing units on a single computing component. Each component of the notification service 212 can be based on any of these processors, or any other processor capable of operating as described herein. Each processor 260 can utilize instruction level parallelism, thread level parallelism, different levels of cache, etc. For example, the notification service 212 can include at least one logic device such as a computing device or server having at least one processor 260 to communicate via a network 208. The components and elements of the notification service 212 can be separate components or a single component. For example, the notification service 212 can include combinations of hardware and software. The notification service 212 can include a structured set of data. For example, the notification service 212 can include and/or store a plurality of notifications 270 and/or subsets 272 of notifications. The notification service 212 can include a memory component 262 (e.g., memory to store and retrieve data. The memory 262 can include a random access memory (RAM) or other dynamic storage device, coupled with the notification service 212 for storing information, and instructions to be executed by the notification service 212. The memory 262 can include at least one read only memory (ROM) or other static storage device coupled with the notification service 212 for storing static information and instructions for the notification service 212. The memory 262 can include a storage device, such as a solid state device, magnetic disk or optical disk, coupled with the notification service 212 to persistently store information and instructions.

The notification service 212 can connect with one or more other applications 230 to receive and/or intercept notifications from the other applications 230. The other applications 230 can include cloud based applications 230, web based applications 230, other virtualized applications 230 (e.g., different from the virtualized applications 204 executing on the virtual machine 202), Software as a service (SaaS) applications 230, and/or file systems 232. The other applications 230 can include applications executed by one or more virtual machines 202 or virtual sessions of a user. In embodiments, the other applications 230 may include applications (apps) that are served from and/or hosted on one or more servers (e.g., third part servers). The other applications 230 can include applications (apps) that are served from and/or hosted on one or more servers, such as but not limited to, web applications, software-as-a-service (SaaS) applications, and/or remote-hosted applications. The other applications 230 can include, but not limited to, a web application, a desktop application, remote-hosted application, a virtual application, a software as a service (SaaS) application, a mobile application, an HDX application, a local application, a native application (e.g., native to device 250), and/or a device coupled with one or more devices 250. The notification service 212 can collect and aggregate the notifications 270 from the other applications 230 with the notifications 270 received from the agent 210.

The notification service 212 can include an aggregated notification database 240. The aggregated notification database 240 can include or correspond to a database or memory to collect, store, aggregate and sort notifications 270. For example, the aggregated notification database 240 can include a plurality of entries. The aggregated notification database 240 can be arranged by user, by notification 270, by a source that generated the notifications 270 (e.g., application 204, operating system 206, other applications 230, file systems 232). The aggregated notification database 240 can include or correspond to a memory. The memory can be implemented using hardware or a combination of software and hardware. For example, each component of the aggregated notification database 240 can include logical circuity (e.g., a central processing unit or CPU) that responses to and processes instructions fetched from a memory unit or database. The aggregated notification database 240 can include or correspond to a random access memory (RAM) or other dynamic storage device, coupled with the processor for storing information, and instructions to be executed by the notification service 212. The aggregated notification database 240 can include or correspond to at least one read only memory (ROM) or other static storage device coupled with the processor for generating and storing notifications 270 and/or subsets 272 of notifications. The aggregated notification database 240 can include or correspond to a storage device, such as a solid state device, magnetic disk or optical disk, coupled with the processor to persistently store information and instructions. The aggregated notification database 240 can include at least one subset 272 of notifications having a plurality of notifications 270 generated for, intended for or directed to at least one user. The aggregated notification database 240 can include a plurality of subsets 272 of notifications, each of the plurality of subsets 272 having a plurality of notifications 270 generated for, intended for or directed to at least one user.

In embodiments, the notification service 212 can include a notification algorithm. The notification algorithm can include a filter, a set of instructions or logic, functions and/or rules to process, aggregate and sort notifications 270. In some embodiments, the notification algorithm can be implemented using hardware or a combination of software and hardware. For example, the notification algorithm can include logical circuity (e.g., a central processing unit or CPU) that responses to and processes instructions fetched from a memory unit (e.g., memory). The notification algorithm can include or execute policies and/or rules to sort and filter a plurality of notifications 270 based in part on an intended user or on a per user basis. For example, the policies can include rules for determining an intended user a notification 270 was generated for. The policies can include rules for determining a virtualized application 204, an operating system, other applications 230 and/or a file system 232 that generated a notification 270. The policies can include rules for sorting a plurality of notifications 270 into one or more subsets 272 of notifications based in part on a user.

The device 250 can be an instance of any client device or computer device described herein. For example, the device 250 can be the same as or substantially similar to computing device 101 of FIG. 1A. The device 250 can include an end point associated with a user. For example, the device 250 can include or provide an application, a virtual desktop, a desktop session, a virtual desktop environment or a workspace application for a user. In embodiments, the device 250 workspace application executing on the device 250 for a user. The device 250 can include, but not limited to, a computing device or a mobile device. The device 250 can include a native operating system 252. The native operating system 252 can include software that supports or provides functions for the device 250 and/or one or more sessions executing on the device 250. In embodiments, the operating system 252 can include software that runs on the device 250 or is executed by the device 250.

The device 250 can include a notification system 254. The notification system 254 can include an agent, function, protocol or set of instructions executing on the device 250 to receive notifications 270 and/or subsets 272 of notifications from the notification service 212 of the server 220. The notification system 254 can include one or more processors 260 coupled to a memory 262. The processor 260 can include or be coupled to a non-volatile memory that stores computer instructions and an operating system. For example, the computer instructions can be executed by the processor 260 out of volatile memory to perform all or part of the method 300. The notification system 254 can include or execute policies and/or rules to receive and collet one or more notifications 270 and/or one or more subsets 272 of notifications for a user of the device 250 or a plurality of users of the device 250. The notification system 254 can include or execute policies and/or rules to sort and filter a plurality of notifications 270 based in part on an intended user or on a per user basis.

The device 250 can couple with the server 220 and notification service 212 through one or more connections 292. The connections 292 can include, an application session, an execution session, a desktop session, a hosted desktop session, a terminal services session, a browser session, a remote desktop session, a URL session, a workspace session and a remote application session. The connections 292 may include encrypted and/or secure sessions established between a device 250 and server 220. For example, the connection 292 may include an encrypted session and/or a secure session established between a device 250 and a server 220. The encrypted connection 292 can include an encrypted file, encrypted data or traffic transmitted between a device 250 and the server 220.

The virtual machine 202 can communicate with the server 220 and notification service 212 through one or more connections 292. The connections 292 can include, an application session, an execution session, a desktop session, a hosted desktop session, a terminal services session, a browser session, a remote desktop session, a URL session, a workspace session and a remote application session. The connections 292 may include encrypted and/or secure sessions established between a virtual machine 202 and server 220. For example, the connection 292 may include an encrypted session and/or a secure session established between a virtual machine 202 and the server 220. The encrypted connection 292 can include an encrypted file, encrypted data or traffic transmitted between a virtual machine 202 and the server 220 by the agent 210 and/or notification service 212.

Network 208 may be a public network, such as a wide area network (WAN) or the Internet. In some embodiments, network 208 may be a private network such as a local area network (LAN) or a company Intranet. Network 208 may be a public network, such as a wide area network (WAN) or the Internet. Network 208 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. I

Each of the above-mentioned elements or entities is implemented in hardware, or a combination of hardware and software, in one or more embodiments. Each component of the virtual machine 202 may be hosted by or implemented using hardware or a combination of hardware or software detailed above in connection with FIG. 1A. For instance, each of these elements or entities can include any application, program, library, script, task, service, process or any type and form of executable instructions executing on hardware of a client device (e.g., the device 250). The hardware includes circuitry such as one or more processors in one or more embodiments.

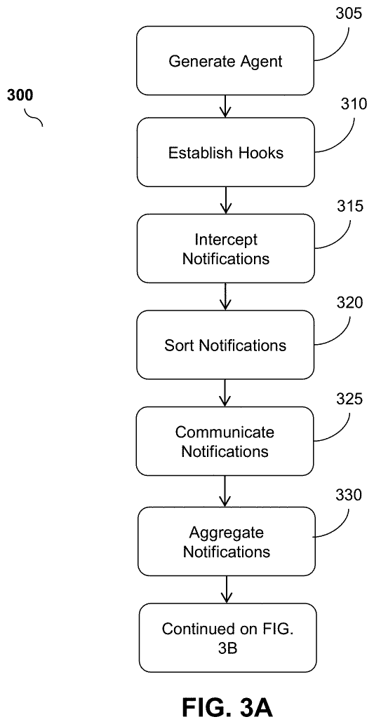

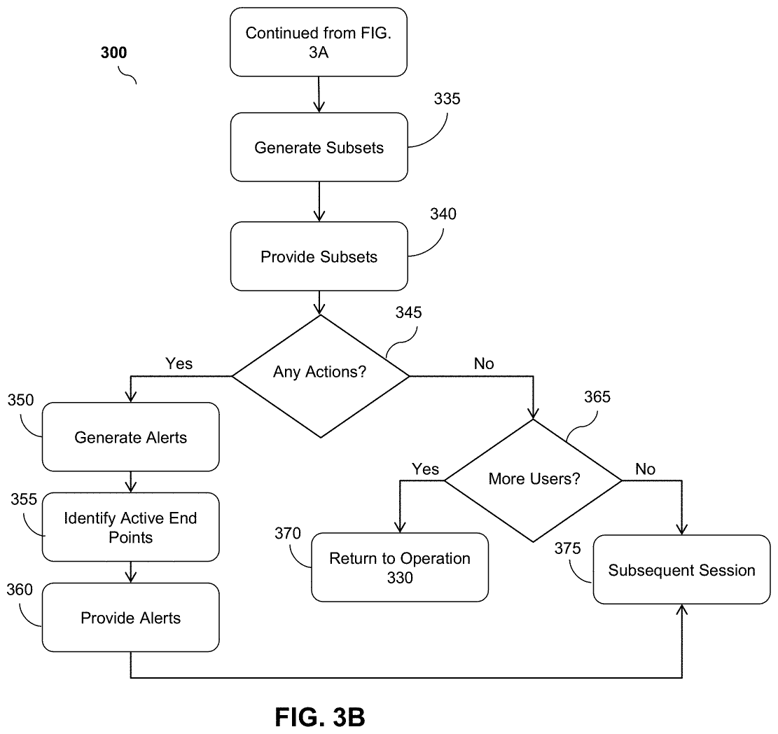

Referring now to FIGS. 3A-3B, depicted is a flow diagram of one embodiment of a method 300 for controlling delivery of notifications. The functionalities of the method 300 may be implemented using, or performed by, the components detailed herein in connection with FIGS. 1-2.

Referring now to operation (305), and in some embodiments, an agent 210 can be generated. The agent 210 can be generated and deployed on one or more virtual machines 202. In embodiments, a single agent 210 can be deployed and run on a virtual machine 202. In some embodiments, multiple agents 210 can be deployed and run on a virtual machine 202. The virtual machines 202 can include, but not limited to, a virtual session or a virtual desktop. The virtual machine 202 can include a file or an image configured to provide the functionality of a client device or computer (e.g., computer 101 of FIG. 1A). In some embodiments, the virtual machine 202 can provide or execute a session (e.g., user session) for a user. The virtual machine 202 can provide or execute a session within which one or more within which applications execute on behalf of a user or a client computing device, such as a hosted desktop session. The virtual machine 202 can provide or execute a session within which one or more within which one or more virtualized applications 204a-204n execute on behalf of a user or a client computing device, such as a hosted desktop session. In embodiments, the one or more virtualized applications 2044-204n can be executing on or running on the virtual machine 202. The virtual machine 202 can include an operating system 206. The operating system 20 can include software that supports or provides functions for the virtual machine 202. In embodiments, the operating system 206 can include software that runs within or on the virtual machine 202 or software that runs within or on a device or server providing the virtual machine 202. In embodiments, the operating system 206 can include software that is executed by the virtual machine 202 or software that is executed by a device or server providing the virtual machine 202.

The virtual machine 202 can include a plurality of user profiles 214. The user profiles 214 can correspond to a plurality of users having access to the virtual machine 202. The user profiles 214 can include a plurality of entries and each entry can correspond to a unique user. Each entry can include a user identifier, account information for a user, password data for a user, and/or virtualized applications 204 accessed or associated with the user. The agent 210 can store user data for one or more users of the virtual machine 202 in a user profile corresponding to the user. The agent 210 can maintain and update the user profiles for one or more users of the virtual machine 202.

Referring now to operation (310), and in some embodiments, a hook 290 can be established. In embodiments, the agent 210 executed by a virtual machine 202 can establish one or more hooks 290 to intercept notifications 270 from an operating system 206 of the virtual machine and one or more virtualized applications 204 executed by the virtual machine 202 accessible by a plurality of users. The agent 210 can establish a hook 290 to at least one virtualized application 204 executed by the virtual machine 202. The agent 210 can establish a hook 290 to two or more virtualized applications 204 executed by the virtual machine 202. The agent 210 can establish a hook 290 to each virtualized application 204 executed by the virtual machine 202. The agent 210 can hook the operating system 206 of the virtual machine 202 to intercept and receive notifications 270 generated by the operating system 206. In embodiments, the agent 210 can include a function, protocol, or hooking tool to intercept or receive notifications generated by the virtualized applications 204 and/or the operating system 206 of the virtual machine 202.

The notifications 270 can include any form or data or information generated by a virtualized application 1204 or operating system 206 for delivery to the virtual machine 202, a device 250 or end point of a user. The notifications 270 can include, but not limited to, text, data, images or a combination of text, data, and/or images. The notifications 270 can include, but not limited to, advertisements, messages, messaging tools, dialogue boxes, text messages, popup windows, dialog windows, context popups, push notifications, email notifications, desktop notifications, and/or banners.

Referring now to operation (315), and in some embodiments, a notification 270 can be intercepted. In embodiments, the agent 210 can intercept, via the one or more hooks 290, a plurality of notifications 270 for a plurality of users generated by the one or more virtualized applications 204 or the operating system 206. The agent 210 can intercept or receive at least one notification 270 through the hooks 290 established to the virtualized applications 204 or the operating system 206. The notification 270 can be intended for, generated for, and/or directed to at least one user of the virtual machine 202.

The agent 210 can determine properties of the notification 270. For example, the agent 210 can determine whether a virtualized application 204 or the operating system 206 generated the notification 270. In embodiments, the agent 210 can determine which virtualized application 204 generated the notification 270. The agent 210 can determine a user associated with the notification 270. For example, the agent 210 can determine each of the users associated with the notification 270, that the notification 270 applies to or that the notification 270 is intended for. In some embodiments, the notification 270 can be intended for or associated with multiple users. For example, the notification 270 can be generated by a virtualized application 204 used by or accessible to multiple users through the virtual machine 202 or multiple virtual machines 202. The agent 210 can determine each of the users associated with the notification 270, that the notification 270 applies to or that the notification 270 is intended for.

Referring now to operation (320), and in some embodiments, notifications 270 can be sorted. In embodiments, the agent 210 can sort or organize the plurality of notifications 270 on a per user basis. For example, the agent 210 can sort the plurality of notifications 270 based in part on a variety of different properties. The agent 210 can sort the plurality of notifications 270 based in part on the virtualized application 204 or operating system 206 that generated the notifications 270. The agent 210 can sort the plurality of notifications 270 based in part on a user the notifications 270 are intended for, generated for, and/or directed to. The agent 210 can sort the plurality of notifications 270 based in part on a group of users (e.g., coworkers) the notifications 270 are intended for, generated for, and/or directed to.

In some embodiments, the agent 210 can apply a notification algorithm to the plurality of notifications 270 to organize or group the notifications based on at least one property (e.g., user). For example, the agent 210 can apply the notification algorithm having one or more policies to identify properties (e.g., user, virtualized application 204, operating system 206) of the notifications 270 and group or partition the notifications 270 into subsets 272 of notifications. The subsets 272 can include one or more notifications 270 associated with at least one common user. For example, the subsets 272 can include one or more notifications 270 intended for, generated for, and/or directed to the same user or same group of users. In embodiments, the agent 210 can generate a single subset 272 of notifications. In some embodiments, the agent 210 can generate two or more subsets 272 of notifications. The number of subsets 272 can correspond to the number of users of the virtual machine 202 or a plurality of virtual machines 202. The agent 210 can generate the plurality of subsets 272 of notifications the per user basis such that each of the subsets 272 of notifications are intended for a different user of the plurality of users.

In embodiments, the agent 210 can generate the plurality of subsets 272 of notifications based in part on a priority, a time, a type of application the notification 270 was received from or generated by and/or user preferences. For example, responsive to sorting the notifications 270 on a per user basis, the notifications 270 can be sorted based on a priority given to an application 204 that generated or provided the respective notification 270. For example, notifications 270 having the same priority or within a range of priority levels can be sorted or grouped together into a subset 272 of notifications. The notifications 270 can be sorted based on a time the respective notification 270 was generated and/or hooked by the agent 210. For example, notifications 270 generated and/or received at the same time or within the same time range can be sorted or grouped together into a subset 272 of notifications. The notifications 270 can be sorted based on a type of application 204 of the application 204 that generated or provided the respective notification 270. For example, notifications 270 from the same type of applications or similar types of applications 204 can be sorted or grouped together into a subset 272 of notifications. The notifications 270 can be sorted based on user preferences. For example, notifications 270 can sorted or grouped into a subset 272 of notifications based in part on a request from a user or based on one or more preferences from a user.

Referring now to operation (325), and in some embodiments, notifications 270 can be communicated. The agent 210 can communicate or forward the plurality of notifications to a notification service 212. In embodiments, the notification service 212 can receive from the agent 210 executing in the virtual machine 202, the plurality of notifications 270 for a user from virtualized applications 204 executed by the virtual machine 202. The agent 210 can communicate or forward the subsets 272 of notifications to the notification service 212. In embodiments, the agent 210 can communicate each user's notifications 270 to a notification service 212 to sort with notifications 270 from a plurality of applications 204 used by each of the plurality of users.

The notification service 212 can be executing on a device or server 220. In embodiments, the device or server 220 can be the same as the device or server hosting or providing the virtual machine 202. The notification service 212 can be executing on remote device or remote server 220 that is different than or remote from a device or server hosting or providing the virtual machine 202. In some embodiments, the notification service 212 can be hosted by or executing on a cloud based service or cloud based server 220. The agent 210 can communicate the plurality of notifications 270 to the notification service 212 through a connection 292 established between the agent 210 and the notification service 212 and/or between a connection 292 established between the virtual machine 202 the agent 210 is executing on and the notification service 212.

In embodiments, the notification service 212 can receive notifications 270 from other applications 230 of the user. For example, the notification service 212 can receive or intercept notifications 270 generated by other applications 230, other than the virtualized applications 204 executing on the virtual machine 202. The notification service 212 can receive notifications 270 generated by other applications 230 from a variety of different sources. In embodiments, the other applications 230 can include, but not limited to, cloud based applications 230, web based applications 230, other virtualized applications 230 (e.g., different from the virtualized applications 204 executing on the virtual machine 202), Software as a service (SaaS) applications 230, and/or file systems 232.

Referring now to operation (330), and in some embodiments, notifications 270 can be aggregated. In embodiments, the notification service 212 can aggregate notifications 270 for the user from the plurality of virtualized applications 204 and the plurality of other applications 230. The notification service 212 can collect and combine the plurality of notifications 270 for a plurality of users. The notification service 212 can collect and aggregate the plurality of notifications 270 on a per user basis to identify notifications 270 for particular users. For example, the agent 210 can sort the plurality of notifications 270 based in part on a variety of different properties. The notification service 212 can sort each user's notifications 270 from the virtual machine 202 with notifications of the user with notifications 270 from a cloud based application 230, web application 230 and/or a file system 232. The notification service 212 can sort each user's notifications 270 from the virtual machine 202 with notifications 270 received from other applications 230 and corresponding to the user, including other applications 230 such as, but not limited to, cloud based applications 230, web based applications 230, other virtualized applications 230 (e.g., different from the virtualized applications 204 executing on the virtual machine 202), Software as a service (SaaS) applications 230, and/or file systems 232. For example, the notification service 212 can sort the plurality of notifications 270 from the virtualized applications 204, the operating system 206, the other applications 230, and/or the file system 232. In some embodiments, the notification service 212 can receive the plurality of notifications 270 unsorted by the agent 210. The notification service 212 can aggregate the notifications 270 from the agent 210 executing on the virtual machine 202 with the notifications 270 received from other applications 230 and/or a file system 232. The notification service 212 can sort the plurality of notifications 270 based in part on the virtualized application 204, operating system 206, and/or other application 230 that generated the notifications 270. The notification service 212 can sort the plurality of notifications 270 based in part on a user the notifications 270 are intended for, generated for, and/or directed to. The notification service 212 can sort the plurality of notifications 270 based in part on a group of users (e.g., coworkers) the notifications 270 are intended for, generated for, and/or directed to.

Referring now to operation (335), and in some embodiments, subsets 272 of notifications can be generated. In embodiments, the notification service 212 can generate a plurality of subsets 272 of notifications on a per user basis. For example, each of the subsets 272 of notifications can be generated for and/or intended for a different user of the plurality of users. The notification service 212 can apply a notification algorithm (e.g. sorting algorithm) to the plurality of notifications 270 to sort, organize or group the notifications based on at least one property (e.g., user). For example, the notification service 212 can apply the notification algorithm having one or more policies to identify properties (e.g., user, virtualized application 204, operating system 206, other applications 230) of the notifications 270 and group or partition the notifications 270 into subsets 272 of notifications. The subsets 272 can include one or more notifications 270 associated with at least one common user. For example, the subsets 272 can include one or more notifications 270 intended for, generated for, and/or directed to the same user or same group of users. In embodiments, the notification service 212 can generate a single subset 272 of notifications. In some embodiments, the notification service 212 can generate two or more subsets 272 of notifications.

In some embodiments, the notification service 212 can receive the plurality of notifications 270 sorted by the agent 210. For example, the notification service 212 can receive the subsets 272 of notifications sorted by user. The notification service 212 can sort the notifications 270 received from other applications 230 or file systems 232 separately from the notifications 270 received from the agent 210 or the subsets 272 of notifications received from the agent 210. The notification service 212 can sort the notifications 270 received from other applications 230 into subsets 272 of notifications. The subsets 272 can include one or more notifications 270 associated with at least one common user. The notification service 212 can aggregate or combine the subsets 272 of notifications received from the agent 210 corresponding to notifications 270 from virtualized applications 204 and/or operating system 20 with the subsets 272 of notifications generated by the notification service 212 and corresponding to notifications 270 from other applications 230 and/or file systems 232. The notification service 212 can aggregate or combine the subsets 272 of notifications 270 based on user. For example, notification service 212 can identify subsets 272 of notifications generated for or associated with the same user and aggregate the multiple subsets 272 into a single subset 272 of notifications for the respective user. In some embodiments, the notification service 212 can combine or aggregate the sorted subsets 272 of notifications with the notifications 270 received from the other applications 230. The notification service 212 can further sort the aggregated notifications 270, including the subsets 272 and the notifications 270 from other applications 230, to generate new subsets 272 of notifications 272. The new subsets 272 of notifications 272 can be sorted by user and include notifications 270 from the virtualized applications 204, the operating system 206, the other applications 230, and/or the file system 232.

The notification service 212 can collect and combine the plurality of notifications 270 from the different sources and/or different applications 204, 230 to identify each notification 270 generated for a particular user. The notification service 212 can generate the plurality of subsets 272 of notifications the per user basis such that each of the subsets 272 of notifications are intended for a different user of the plurality of users. In some embodiments, duplicate notifications 270, repeat notifications 270 and/or noise can be identified in the plurality of notifications 270 or subsets 272 of notifications. For example, the notification service 212 can identify duplicate notifications 270 for the user received from the one or more virtualized applications 204, the operating system 206, the other applications 230 and/or the file systems 232. The duplicate notifications 270 can include the same notifications 270 generated by different sources. The duplicate notifications 270 can include the same notifications 270 generated by the same sources executed by different virtual machines 202 or different computing environments. The duplicate notifications 270 can include the same notifications 270 including the same subject matter or corresponding to similar subject matter. For example, in one embodiment, the duplicate notifications 270 can include time alerts generated by different sources but corresponding to the same time alert. The notification service 212 can remove or delete the duplicate notifications from the plurality of notifications 270 and/or from the subsets 272 of notifications for each user of the plurality of users. For example, the notification service 212 can remove or delete the duplicate notifications from the plurality of notifications 270 such that the plurality of notifications 270 include one version or one copy of the notification 270 and not multiple versions or copies of the notification 270. The notification service 212 can remove or delete the duplicate notifications from the subsets 272 of notifications such that the subsets 272 of notifications include one version or one copy of the notification 270 and not multiple versions or copies of the notification 270.

Referring now to operation (340), and in some embodiments, subsets 272 of notifications can be provided. In embodiments, the notification service 212 can communicate notifications 270 sorted between the plurality of applications 204, 230 to one or more devices 250 of the user. The notification service 212 can communicate or provide the subsets 272 of notifications for a user to at least one device 250 of the user. In some embodiments, the notification service 212 can identify one or more devices 250 of a user or associated with a user. The notification service 212 can select one or more notifications 270 from the plurality of notifications 270 to provide to a device 250 of a user. For example, the notification service 212 can select one or more notifications 270 from the aggregated notifications 270 of the user. In some embodiments, the notification service 212 can select one or more notifications 270 from the subsets 272 of the aggregated notifications 270 of the user. At least one of the one or more notifications 270 can include a notification 270 to the user from a virtualized application 204, an operating system 206, other application 230 and/or or a file system 232. The notification service 212 can communicate the selected one or more notifications 270 or subsets 272 to a notification system 254 of the device 250 of the user.

In some embodiments, the notification service 212 can identify one or more devices 250 of a user or associated with a user. The notification service 212 can identify the devices 250 using a user profile 214 for the user. In embodiments, the notification service 212 can determine a status of one or more end points (e.g., virtual sessions, desktops, machines) and/or devices 250 of a user or associated with a user. The notification service 212 can determine which end points and/or devices 250 associated with the user are active or that the user is actively (e.g., currently) interacting with. The notification service 212 can determine which devices 250 the user is using to access a virtual machine 202, virtual session or desktop environment. The active devices 250 can be selected by the notification service 212 to receive the notifications 270 for the user.

In embodiments, the notification service 212 can provide the notifications 270 of the user or subsets 272 of notifications of the user to a single device 250 of the user or two or more devices 250 of the user. In some embodiments, the notification service 212 can provide the notifications 270 of the user or subsets 272 of notifications of the user to each device 250 of the user. The notification service 212 can transmit or forward at least one selected notification 270 or subset of notifications 272 to at least one endpoint or at least one device 250 of the user. In embodiments, the notification service 212 can transmit or forward a plurality of selected notification 270 or a subsets of notifications 272 to a plurality of endpoints or a plurality of devices 250 of the user.

In some embodiments, responsive to one or more notifications 270 or a subset 272 of notifications, a virtual session of the user can be established by the user on the device 250 of the user to connect to the virtualized application 204 that generated or is associated with the respective notification 270. For example, the notification service 212 can provide a notification 270, a subset 272 of notifications, an action 280 corresponding to a notification 270 or an alert 282 corresponding to a notification 270 to a notification system 254 executing on one or more devices 250 of the user. The notification system 254 can provide the notification 270, the subset 272 of notifications, the action 280 corresponding to the notification 270 or the alert 282 corresponding to the notification 270 to a user through the device 250, such as but not limited to, through a browser or display portion of the device 250.

In embodiments, the notification system 254 can instruct an operating system 252 of the device 250 to initiate the virtualized application 204 associated with the notification 270, subset 272, action 280, or alert 282 responsive to the notification system 254 receiving the notification 270, subset 272, action 280, or alert 282 from the notification service 212 on the server 220. In some embodiments, the virtualized application 204 can be initiated responsive to an instruction or command can be received from a user (e.g., user of a device 250) through a user interface. The native OS 252 can receive the command, for example, through a user interaction with the user interface of device 250, to initiate the virtualized application 204 associated with the notification 270, subset 272, action 280, or alert 282. The user can interact with, in some embodiments, a touch screen of the device 250 to response to a notification 270, subset 272, action 280, or alert 282 from the notification service 212 on the server 220. The user interaction can initiate a new session with the virtualized application 204 or re-connect an existing or previous session with the virtualized application 204.

In some embodiments, an operating system 252 of the device 250 can initiate the virtualized application 204 associated with the notification 270, subset 272, action 280, or alert 282 responsive to the notification system 254 receiving the notification 270, subset 272, action 280, or alert 282 from the notification service 212 on the server 220. For example, a new session can be established on the device 250 for the user to perform a task associated with the notification 270, acknowledge the notification 270 or otherwise interact with the virtualized application 204 regarding the notification 270. In some embodiments, a previous session can be re-established or re-connected on the device 250 for the user to perform a task associated with the notification 270, acknowledge the notification 270 or otherwise interact with the virtualized application 204 regarding the notification 270. In embodiments, an idle session can be re-activated on the device 250 for the user to perform a task associated with the notification 270, acknowledge the notification 270 or otherwise interact with the virtualized application 204 regarding the notification 270. In some embodiments, the new, previous or idle session can be established on device 250 for example, through a virtual machine 202 executing on the device 250.

Referring now to operation (345), and in some embodiments, actions 280 can be identified. In embodiments, the notification service 212 can determine if any actions 280 have been received from one or more of the virtualized applications 204, the operating system 206 of the virtual machine 202, the other applications 230 and/or the file system 232. In embodiments, the action 280 can include, but not limited to, for a user to review a completed download or rendering of a file through a virtualized application 204 executed by the virtual machine 202. In some embodiments, the action 280 can include, but not limited to, for a user to accept or decline a meeting invitation through an email application. The notification service 212 can generate a request to one or more agents 210 executed by one or more virtual machines 202 to determine if any actions 280 have been issued. For example, the notification service 212 can identify, via the agent 210, an action 280 requested by the one or more virtualized applications 204, the operating system 206 of the virtual machine 202, the other applications 230 and/or the file system 232. The action 280 can correspond to at least one selected notification 270 or at least one notification 270 of the subset 272 of notifications. The action 280 can include requests from at least one of the virtualized applications 204, the operating system 206 of the virtual machine 202, the other applications 230 and/or the file system 232 for a user to perform a task, an act, or otherwise interact with the at least one of the virtualized applications 204, the operating system 206 of the virtual machine 202, the other applications 230 and/or the file system 232. The notification service 212 can identify at least one user of the plurality of users associated with a virtual machine 202 that the action 280 was generated for or the action 280 is to be completed using. The notification service 212 can provide or forward the action 280 to a device associated with the user. For example, in some embodiments, the notification service 212 can provide the notification 270, a subset 272 of notifications and/or one or more actions 280 correspond to a notification to a notification system 254 executing on one or more devices 250 of the user. The notification system 254 can provide the notification 270, a subset 272 of notifications and/or one or more actions 280 to a user through the device 250, such as but not limited to, through a browser or display portion of the device 250.

Referring now to operation (350), and in some embodiments, if one or more actions 280 are identified, one or more alerts 282 can be generated. In embodiments, the notification service 212 can generate an alert 282 for the device 250 of the user to indicate an action 280 requested by the one or more virtualized applications 204, the operating system 206 of the virtual machine 202, the other applications 230, and/or the file system 232. The alerts 282 can include notifications generated by the notification service 212 responsive to an action 280 and/or notifications intercepted from the one or more virtualized applications 204, the operating system 206 of the virtual machine 202, the other applications 230, and/or the file system 232.

Referring now to operation (355), and in some embodiments, active end points can be identified. The notification service 212 can identify a status one or more end points or devices 250 of a user or associated with a user. The notification service 212 can determine which end points and/or devices 250 associated with the user are active or that the user is actively (e.g., currently) interacting with. The notification service 212 can determine which devices 250 the user is using to access a virtual machine 202, virtual session or desktop environment. The active devices 250 can be selected by the notification service 212 to receive one or more alerts 282 for the user.

Referring now to operation (360), and in some embodiments, alerts 282 can be provided. The notification service 212 can provide at least one alert 282 to at least one device 250 or end point of the user. In some embodiments, the notification service 212 can provide a plurality of alerts 282 to one or more devices 250 of the user. The plurality of alerts 282 can correspond to the selected one or more notifications 270 or subset 272 of notifications. For example, the plurality of alerts 282 can correspond to actions 280 generated in response to the selected one or more notifications 270 or subset 272 of notifications. The notification service 212 can provide or forward an alert 282 to a device associated with the user. For example, in some embodiments, the notification service 212 can provide the alert 282 or a plurality of alerts 282 to a notification system 254 executing on one or more devices 250 of the user. The notification system 254 can provide the alert 282 or plurality of alerts 282 to a user through the device 250, such as but not limited to, through a browser or display portion of the device 250.

In some embodiments, a selected notification 270 or a subset 272 of notifications can be provided to a device 250 through a feed service or through a client application executing on a device 250. For example, a client application can be executing on the device 250 to provide a session to at least one virtualized application 204. In some embodiments, the client application can be executing on the device 250 to connect with the notification service 212 of server 220 and/or a virtual machine 202. The notification service 212 can connect with the client application to provide one or more selected notifications 270 and/or a subset 272 of notifications to a user of the device 250.

In embodiments, a selected notification 270 or a subset 272 of notifications can be provided to a device 250 based in part on user preferences and/or analytics corresponding to a user of the device 250. For example, the selected notification 270 or subset 272 of notifications can be provided to a user of a device 250 based on a priority given to an application 204 that generated or provided the respective notification 270. For example, notifications 270 having a higher priority or a priority above a priority threshold can be provided to the device 250 and notifications 270 having a lower priority or a priority that is less than or below a priority threshold can be prevented from being received at the device 250. The notifications 270 can be provided to the device 250 or blocked from being received at the device 250 based on a time the respective notification 270 was generated and/or hooked by the agent 210. The notifications 270 can be provided to the device 250 or blocked from being received at the device 250 based on a type of application 204 of the application 204 that generated or provided the respective notification 270.

Referring now to operation (365), and in some embodiments, if no actions 280 are identified or remaining, remaining users can be determined. The notification service 212 can continually review the plurality of notifications 270 and/or subsets 272 of notifications to identify each user having at least one notification 270 generated for, intended for or directed to the respective user. The notification service 212 can determine if notifications 270 have been collected and/or sorted for each session through a virtual machine 202. The notification service 212 can determine if notifications 270 have been collected and/or sorted for each user having a session through a virtual machine 202.

Referring now to operation (370), and in some embodiments, if notifications 270 for one or more users still need to be sorted, the method 300 can return operation 330 to sort subsequent notifications 270 for a different or subsequent user. The notification service 212 can continually review the plurality of notifications 270 and/or subsets 272 of notifications to identify each user having at least one notification 270 generated for, intended for or directed to the respective user. The notification service 212 can provide or push notifications for a user to least one device 250 associated with the respective user. The notification service 212 can continually review the notifications 270 until each notification 270 has been sorted or discarded (e.g., duplicates). In some embodiments, the notification service 212 can continually review the notifications 270 until each notification 270 has been provided or pushed to at least one device 250 or end point of a corresponding user. Referring now to operation (375), and in some embodiments, if the notifications 270 have been sorted and provided to each of the users, the notification service 212 can wait for a subsequent session to at least one virtual machine 202 to be initiated to collect and aggregate notifications 270 for the respective session.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

What is claimed is:

1. A method for controlling delivery of notifications based on a user, the method comprising:
(a) establishing, by an agent executed by a virtual machine, one or more hooks to intercept notifications from an operating system of the virtual machine and one or more virtualized applications executed by the virtual machine accessible by a plurality of users;
(b) intercepting, by the agent via the one or more hooks, a plurality of notifications for a plurality of users generated by the one or more virtualized applications or the operating system;
(c) sorting, by the agent, the plurality of notifications on a per user basis; and
(d) communicating, by the agent, each user's notifications to a notification service to sort with notifications from a plurality of applications used by each of the plurality of users.

2. The method of claim 1, wherein the notification service sorts each user's notifications from the virtual machine with notifications of the user from a cloud based application or a file system.

3. The method of claim 1, wherein the notification service communicates notifications sorted between the plurality of applications to one or more devices of the user.

4. The method of claim 1, further comprising identifying, by the notification service, duplicate notifications for the user received from the one or more virtualized applications or the operating system.

5. The method of claim 4, further comprising removing, by the notification service, the duplicate notifications from the plurality of notifications for each user of the plurality of users.

6. The method of claim 1, comprising generating, by the notification service, a plurality of subsets of notifications, each of the subsets of notifications intended for a different user of the plurality of users.

7. The method of claim 1, comprising identifying, by the notification service via the agent, an action requested by the one or more virtualized applications or the operating system of the virtual machine, the action corresponding to at least one notification of the subset of notifications.

8. The method of claim 7, comprising:
identifying, by the notification service, at least one user of the plurality of users associated with the virtual machine; and
providing, by the notification service, the action to a device associated with the user.

9. A method comprising
(a) receiving, by a notification service from an agent executed by a virtual machine, a plurality of notifications for a user from virtualized applications executed by the virtual machine;
(b) receiving, by the notification service, notifications from other applications of the user;
(a) aggregating, by the notification service, notifications for the user from the plurality of virtualized applications and the plurality of other applications;
(d) selecting, by the notification service, one or more notifications from the aggregated notifications of the user, at least one of the one or more notifications comprising a notification to the user from a virtualized application; and
(e) communicating, by the notification service, the selected one or more notifications to a notification system of a device of the user;

10. The method of claim 9, wherein responsive to the one or more notifications, a virtual session of the user is established by the user on the device of the user to connect to the virtualized application.

11. The method of claim 9, wherein the notifications from the other applications include at least one of a web application notifications, a Software as a service (SaaS) application notifications, or a file notifications.

12. The method of claim 1, comprising generating, by the notification service, an alert for the device of the user to indicate an action requested by the one or more virtualized applications or the operating system of the virtual machine.

13. The method of claim 1, comprising providing, by the notification service, a plurality of alerts to one or more devices of the user, the plurality of alerts corresponding to the selected one or more notifications.

14. A system for controlling delivery of notifications based on a user, the system comprising:
an agent executed by a virtual machine, the agent having one or more processors coupled to a memory, the agent configured to:
establish one or more hooks to intercept notifications from an operating system of the virtual machine and one or more virtualized applications executed by the virtual machine accessible by a plurality of users;
intercept, via the one or more hooks, a plurality of notifications for a plurality of users generated by the one or more virtualized applications or the operating system;
sort the plurality of notifications on a per user basis; and
communicate each user's notifications to a notification service to sort with notifications from a plurality of applications used by each of the plurality of users.

15. The system of claim 14, wherein the notification service is configured to sort each user's notifications from the virtual machine with notifications of the user from a cloud based application or a file system.

16. The system of claim 14, wherein the notification service is configured to communicate notifications sorted between the plurality of applications to one or more devices of the user.

17. The system of claim 14, wherein the notification service is configured to identify duplicate notifications for the user received from the one or more virtualized applications or the operating system.

18. The system of claim 17, wherein the notification service is further configured to remove the duplicate notifications from the plurality of notifications for each user of the plurality of users.

19. The system of claim 14, wherein the notification service is configured to generate a plurality of subsets of notifications the per user basis, each of the subsets of notifications intended for a different user of the plurality of users.

20. The system of claim 14, wherein the notification service is further configured to identify, via the agent, an action requested by the one or more virtualized applications or the operating system of the virtual machine, the action corresponding to at least one notification of the subset of notifications.
